(19) United States
(12) Patent Application Publication
(10) Pub. No.: US 2026/0303611 A1
(43) Pub. Date: Oct. 1, 2026

(54) PRODUCT RECALL DRIVE MANAGEMENT

(71) Applicant: Honeywell International Inc., Charlotte, NC (US)

(72) Inventors: Ankit Singh, Apex, NC (US); Lakshminarayana Paila, Frisco, TX (US); Jignesh Kansara, Mira-Bhayandar (IN); Amit Kumar, Thane (IN)

(21) Appl. No.: 19/093,312

(22) Filed: Mar. 28, 2025

(51) Int. Cl. H04L 9/40

(52) U.S. Cl. CPC H04L 63/107; H04L 63/08

(57) ABSTRACT

Techniques for managing product recall drives are disclosed. In an example, a logon request is received from a computing device, where the logon request corresponds to a consignee of a product associated with a product recall drive and comprises a first information to facilitate logon of the consignee onto a consignee portal. A geographical location of the computing device is then determined to be within a predetermined range of at least one of expected geographical locations of the consignee. In response to the determination, authenticity of the consignee is verified, and the consignee is logged on onto the consignee portal. The consignee is logged on based on the first information to allow the consignee to provide information corresponding to the product associated with the product recall drive.

### BACKGROUND

Industrial processes in industrial setups are influenced by a complex interplay of various factors. Such factors include material quality of a raw material corresponding to a product being manufactured by an industrial process, calibration of different equipment involved in the industrial process, environmental conditions within the industrial process, and human expertise of the operators involved in the industrial process. Such factors collectively contribute to the product meeting specified quality standards and complying with regulatory requirements. For instance, material quality of the raw material can be paramount, as inconsistencies or defects in inputs can propagate through the entire industrial process. Equipment calibration can play a crucial role in maintaining precision and accuracy, with even minor deviations potentially leading to significant quality issues. Environmental conditions, such as temperature, humidity, and air quality, can have a significant impact on chemical reactions, material properties, and overall integrity of the product. Further, human expertise, including operator skills, decision-making, and adherence to protocols, can be a critical factor to ensure that the product meet specified quality standards and comply with regulatory requirements.

According to a first aspect, a method for managing product recall drives is disclosed. In an example, the method comprises: receiving a logon request from a computing device, wherein the logon request corresponds to a consignee of a product associated with a product recall drive, the logon request comprises a first information to facilitate logon of the consignee onto a consignee portal, and the first information is obtained upon scanning of a unique visual code corresponding to the consignee, through the computing device; identifying a geographical location of the computing device; determining the geographical location of the computing device to be within a predetermined range of at least one of expected geographical locations of the consignee; verifying authenticity of the consignee based on determination of the geographical location of the computing device to be within the predetermined range; and logging on the consignee onto the consignee portal in response to the verifying, wherein the logging on is based on the first information to allow the consignee to provide information corresponding to the product associated with the product recall drive.

According to some examples, the first information comprises at least one of Unified Resource Locator (URL) to the consignee portal and consignee login credentials for the consignee portal.

According to some examples, prior to logging the consignee onto the consignee portal, the method further comprises: receiving a user input regarding an authentication question for re-verifying the authenticity of the consignee; and comparing the user input with a pre-stored value of the authentication question to re-verify the authenticity of the consignee.

According to some examples, the method comprises providing a prompt on the computing device for the consignee to input a value corresponding to the authentication question.

According to some examples, the authentication question is changed for each re-verification.

According to some examples, comparing the user input with the pre-stored value of the authentication question comprises: counting instances of discrepancy in the user input and the pre-stored value of the authentication question; and locking the consignee out of the consignee portal upon determining a count of the instances to be greater than a threshold.

According to some examples, the authentication question is related to personal information of the consignee, transactions corresponding to the consignee, product to be recalled, entity initiating the product recall, or a combination thereof.

According to some examples, the expected geographical locations of the consignee are determined based on a travel history of the consignee.

According to a second aspect, a Recall Drive Management System (RDMS) is disclosed. The RDMS comprises at least one processor and at least one memory storing instructions that, when executed by the at least one processor, cause the RDMS at least to: receive a logon request from a computing device, wherein the logon request corresponds to a consignee of a product associated with a product recall drive, the logon request comprises first information to facilitate logon of the consignee on a consignee portal, and the first information is obtained upon scanning of a unique visual code corresponding to the consignee, through the computing device; identify a geographical location of the computing device; determine the geographical location of the computing device to be within a predetermined range of at least one of expected geographical locations of the consignee; verify authenticity of the consignee based on determination of the geographical location of the computing device to be within the predetermined range; receive a user input regarding an authentication question for re-verifying the authenticity of the consignee; compare the user input with a pre-stored value of the authentication question to re-verify the authenticity of the consignee; and log on the consignee onto the consignee portal in response to the verifying, wherein the logging on is based on the first information to allow the consignee to provide information corresponding to the product associated with the product recall drive.

According to some examples, the first information comprises at least one of URL to the consignee portal and consignee login credentials for the consignee portal.

According to some examples, the authentication question is related to personal information of the consignee, transactions corresponding to the consignee, product to be recalled, entity initiating the product recall, or a combination thereof.

According to some examples, the at least one processor causes the RDMS to provide a prompt on the computing device for the consignee to input a value corresponding to the authentication question.

According to some examples, the authentication question is changed for each re-verification.

According to some examples, to compare the user input with the pre-stored value of the authentication question, the at least one processor causes the RDMS to: count instances of discrepancy in the user input and the pre-stored value of the authentication question; and lock the consignee out the consignee portal upon determining a count of the instances to be greater than a threshold.

According to some examples, the at least one processor causes the RDMS to determine the expected geographical locations of the consignee based on a travel history of the consignee.

According to a third aspect, a non-transitory computer readable medium comprising computer-readable instructions is disclosed. In an example, the execution of the computer-readable instructions cause a processing resource of a computing device to: receive a logon request from a computing device, wherein the logon request corresponds to a consignee of a product associated with a product recall drive, the logon request comprises a first information to facilitate logon of the consignee onto a consignee portal, and the first information is obtained upon scanning of a unique visual code corresponding to the consignee, through the computing device; identify a geographical location of the computing device; determine the geographical location of the computing device to be within a predetermined range of at least one of expected geographical locations of the consignee; verify authenticity of the consignee based on determination of the geographical location of the computing device to be within the predetermined range; and log on the consignee onto the consignee portal in response to the verifying, wherein the logging on is based on the first information to allow the consignee to provide information corresponding to the product associated with the product recall drive.

According to some examples, prior to logging the consignee onto the consignee portal, the instructions cause the computing device to: receive a user input regarding an authentication question for re-verifying the authenticity of the consignee wherein the authentication question corresponds to at least one of the consignee and the product; and compare the user input with a pre-stored value of the authentication question to re-verify the authenticity of the consignee.

According to some examples, the instructions cause the computing device to provide a prompt on the computing device for the consignee to input a value corresponding to the authentication question, and wherein the authentication question is changed for each re-verification.

According to some examples, to compare the user input with the pre-stored value of the authentication question, the instructions cause the computing device to: count instances of discrepancy in the user input and the pre-stored value of the authentication question; and lock the consignee out of the consignee portal upon determining a count of the instances to be greater than a threshold.

According to some examples, the first information comprises at least one of URL to the consignee portal and consignee login credentials for the consignee portal; and the authentication question is related to personal information of the consignee, transactions corresponding to the consignee, product to be recalled, entity initiating the product recall, or a combination thereof.

### BRIEF DESCRIPTION OF DRAWINGS

FIG. 1 illustrates an environment for facilitating management of product recall drives, in accordance with an example of the present subject matter.

FIG. 2 illustrates an environment for facilitating management of product recall drives, in accordance with another example of the present subject matter.

FIG. 3 illustrates a schematic of a Recall Drive Management System (RDMS), in accordance with an example of the present subject matter.

FIG. 4 illustrates the schematic of the RDMS, in accordance with another example of the present subject matter.

FIG. 5 illustrates a method for managing product recall drives, in accordance with an example of the present subject matter.

FIG. 6 illustrates a method for managing product recall drives, in accordance with another example of the present subject matter.

FIG. 7 illustrates a method for managing product recall drives, in accordance with yet another example of the present subject matter.

FIG. 8A and 8B illustrates a method for managing product recall drives, in accordance with yet another example of the present subject matter.

FIG. 9 illustrates a method for managing product recall drives, in accordance with yet another example of the present subject matter.

FIG. 10 illustrates a non-transitory computer-readable medium for managing product recall drives, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

Deviations from established norms can have profound consequences. For instance, deviations from the established norms during an industrial process for manufacturing a product may lead to a situation where the product may fail to meet internal quality benchmarks, potentially compromising performance, durability, or aesthetic attributes. Further, non-compliance with regulatory standards may result in legal infractions, posing risks to consumer safety, environmental protection, or fair-trade practices. Moreover, such deviations can lead to the production of unsafe, environmentally harmful, or misleadingly labelled products.

The economic impact of such deviations can be substantial. Beyond the immediate costs of product recalls or regulatory fines, companies corresponding to the industrial setups may face long-term consequences such as loss of market share, decreased consumer confidence, and damage to brand value. In some cases, such financial repercussions can threaten the viability of the business, especially for smaller enterprises operating in competitive markets.

Such risks are further compounded when non-compliant products are not identified until after consignments have been shipped to consignees. In such situations, a swift mitigative action may be beneficial to address potential risks and maintain public trust. For instance, delivery of non-compliant products to consignees may prompt a product recall to protect consumers from potential harm, maintain market integrity, and fulfil legal and ethical obligations. A product recall drive involves identification of affected batches of the product, tracing distribution channels, and coordinating returns or replacements. Timely and effective recalls are crucial for mitigating risks, preserving brand reputation, and demonstrating corporate responsibility.

Electronic communications, particularly emails, are a primary method for initiating recall drives. Such emails typically contain secure links directing consignees of the product to dedicated consignee portals. The consignees can authenticate their identity on such consignee portals, access detailed information about the product recall drive, and provide critical information about the products in their possession. Such an approach for the product recall drive enables rapid dissemination of information, real-time data collection, and efficient coordination of recall logistics. However, the effectiveness of electronic communications in recall drives can be limited by outdated or missing contact information for consignees. Such challenges are particularly prevalent in industries with complex distribution networks or in regions with limited digital infrastructure.

To address such challenges, manufacturers may resort to physical mail containing information that allows a consignee to logon to a consignee portal and provide critical information about the products in their possession. While the use of physical mail containing information offers a solution for reaching consignees without reliable electronic contact information, it introduces new security vulnerabilities. The tangible nature of physical mail makes it susceptible to interception, loss, or tampering during transit. An unauthorized individual who intercepts such mail could potentially access the consignee portal based on the information contained in the physical mail. Such access could be exploited to submit false information, either to disrupt the product recall drive or to harm a brand’s reputation. The risk is compounded by the fact that the interceptor has the physical possession of the product, allowing them to provide seemingly credible, yet false, information about the condition or location of the product.

According to examples of the present subject matter, techniques for managing product recall drives are described.

In an example of the present subject matter, a logon request corresponding to a consignee of a product associated with a product recall drive is received. The logon request may be received from a computing device in possession of the consignee and may include first information to facilitate logon of the consignee onto a consignee portal. In an example, the first information may be obtained upon scanning of a unique visual code corresponding to the consignee, through the computing device.

A geographical location of the computing device is then identified. It is then determined whether the geographical location is within a predetermined range of at least one of expected geographical locations of the consignee. If the geographical location is determined to be within the predetermined range of at least one of expected geographical locations, the consignee is determined to be an authentic consignee.

In response to determining the authenticity of the consignee, the consignee is logged onto the consignee portal. The consignee is logged onto the consignee portal based on the first information. Further, the consignee is logged onto the consignee portal to allow the consignee to provide information corresponding to the product associated with the product recall drive.

The present subject matter offers a secure way to authenticate consignees during product recall drives, particularly when physical mail is used. By determining the location of the computing device to be within the predetermined range of at least one of the expected geographical locations of the consignee before allowing an individual from logging onto the consignee portal, the present subject matter ensures that the log on request is coming from the consignee of the product and not from an unauthorized individual who may have maliciously intercepted the physical mail. As a result, the present subject matter prevents false information about the condition or location of a product to be recorded, thereby preventing disruption of a product recall drive.

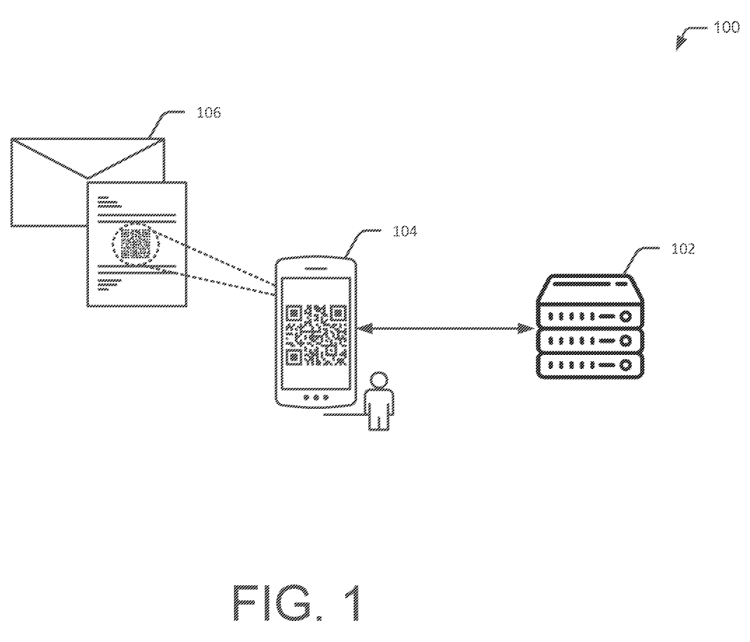

The above techniques are further described with reference to FIGS. 1 to 10. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates an environment for facilitating management of product recall drives, in accordance with an example of the present subject matter.

The environment 100 may include a Recall Drive Management System (RDMS) 102. In an example, the RDMS 102 may facilitate authentication of a consignee of a product associated with a product recall drive, amongst other functions. In the example, the RDMS 102 may be implemented as an authorization server for authenticating the consignee of the product on a consignee portal. The consignee portal may correspond to an entity associated with the product, such as product manufacturer, product supplier, or product distributer. Further, the RDMS 102 may also host the consignee portal.

The environment 100 may further include a computing device 104 coupled to the RDMS 102. Examples of the computing device 104 may include, but are not limited to, laptop, desktop, smartphones, and tablets. Further, the RDMS 102 may be coupled to the computing device 104 either through a direct communication link, or through multiple communication links of a network (not shown). The network may be a wireless or a wired network, or a combination thereof. The network can be a collection of individual networks, interconnected with each other and functioning as a single large network. Examples of such individual networks include, but are not limited to, Global System for Mobile communication (GSM) network, Universal Mobile Telecommunications System (UMTS) network, Long Term Evolution (LTE) network, personal communications service (PCS) network, Time-division multiple access (TDMA) network, Code-Division Multiple Access (CDMA) network, next-generation network (NGN), public switched telephone network (PSTN), and Integrated Services Digital Network (ISDN). Depending on the terminology, the communication network includes various network entities, such as gateways and routers; however, such details have been omitted to maintain the brevity of the description.

The computing device 104 may be utilized to facilitate authentication of the consignee with the RDMS 102, amongst other functions. To facilitate the authentication of the consignee, the computing device 104 may create a logon request corresponding to the consignee. The computing device 104 may create the logon request upon scanning a unique visual code corresponding to the consignee. In an example, the unique visual code may be printed on a physical mail 106 received by the consignee as a part of the product recall drive. In the example, the physical mail 106 may have been sent to the consignee for requesting the consignee to provide information corresponding to the product associated with the product recall drive.

The computing device 104 may obtain a first information upon scanning of the visual code, where the first information may facilitate logon of the consignee onto the consignee portal. The computing device 104 may embed the first information in the log on request. The computing device 104 may then transmit the logon request to the RDMS 102.

The RDMS 102 may receive the logon request including the first information. Upon receiving the logon request, the RDMS 102 may identify a geographical location of the computing device. Subsequently, the RDMS 102 may determine if the geographical location of the computing device is within a predetermined range of at least one of expected geographical locations of the consignee. If it is determined that the geographical location of the computing device is indeed within the predetermined range of at least one of expected geographical locations, the RDMS 102 may verify the authenticity of the consignee.

In response to the verification, the RDMS 102 may log on the consignee onto the consignee portal to allow the consignee to provide information corresponding to the product associated with the product recall drive. In an example, the RDMS 102 may utilize the first information to log on the consignee onto the consignee portal.

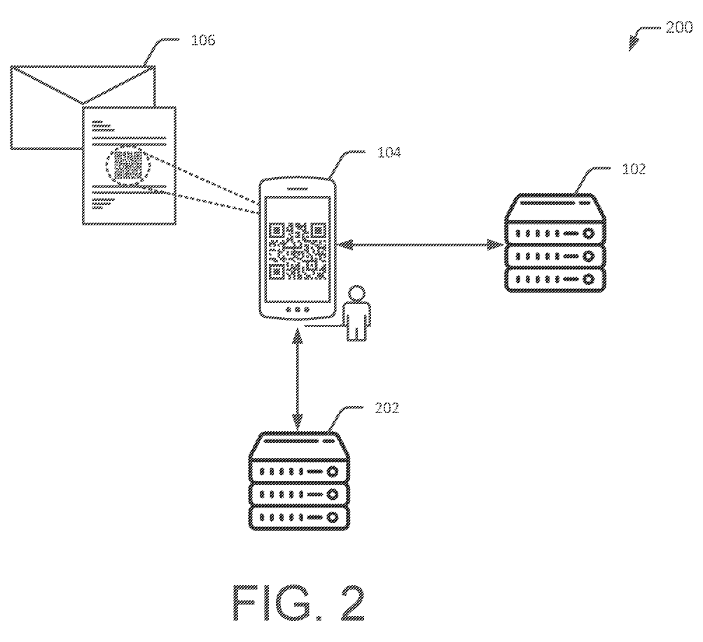

FIG. 2 illustrates an environment for facilitating management of product recall drives, in accordance with another example of the present subject matter.

The environment 200 may include the RDMS 102. As already explained, the RDMS 102 may facilitate authentication of the consignee of the product associated with the product recall drive, amongst other functions. The RDMS 102 may be implemented as an authorization server for authenticating the consignee of the product on the consignee portal. The environment 200 may further include a resource server 202 for hosting the consignee portal.

Further, the environment 200 may include the computing device 104 coupled to the RDMS 102 and the resource server 202. As already described, the computing device 104 may be utilized to facilitate authentication of the consignee with the RDMS 102, amongst other functions. To facilitate the authentication, the computing device 104 may create a logon request corresponding to the consignee. The computing device 104 may create the logon request upon scanning a unique visual code corresponding to the consignee. The unique visual code may be printed on a physical mail 106 received by the consignee as a part of the product recall drive. The physical mail 106 may have been sent to the consignee for requesting the consignee to provide information corresponding to the product associated with the product recall drive.

In an example, the computing device 104 may obtain the first information upon scanning of the visual code, where the first information may facilitate logon of the consignee onto the consignee portal. In the example, the computing device 104 may embed the first information in the logon request. The computing device 104 may then transmit the logon request to the RDMS 102.

The RDMS 102 may then receive the logon request including the first information. Upon receiving the logon request, the RDMS 102 may identify a geographical location of the computing device. Subsequently, the RDMS 102 may determine if the geographical location of the computing device is within a predetermined range of at least one of expected geographical locations of the consignee. If it is determined that the geographical location of the computing device is indeed within the predetermined range of at least one of expected geographical locations, the RDMS 102 may verify the authenticity of the consignee.

In response to the verification, the RDMS 102 may generate an authentication token to authenticate the consignee onto the consignee portal. The RDMS 102 may generate the authentication token based on the first information. The RDMS 102 may then transmit the authentication token to the computing device 104. In an example, the computing device 104 may receive the authentication token from the RDMS 102 and utilize the authentication token to logon the consignee onto the consignee portal hosted on the resource server 202 to provide information corresponding to the product associated with the product recall drive.

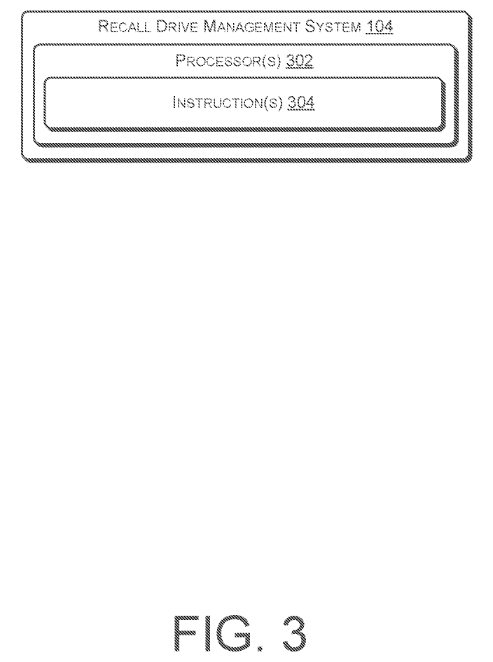

FIG. 3 illustrates a schematic of the RDMS 102, in accordance with an example of the present subject matter. The RDMS 102 may comprise a processor 302. The processor 302 may fetch and execute the computer-readable instructions 304 stored in a memory (not depicted in FIG. 3), to facilitate management of product recall drives, amongst other functions.

In operation, the processor 302 may cause the RDMS 102 to receive the logon request from the computing device 104. The logon request may correspond to the consignee of the product associated with the product recall drive. Further, the logon request may include the first information to facilitate logon of the consignee onto the consignee portal. In an example, the first information may be obtained upon scanning of a unique visual code corresponding to the consignee through the computing device 104.

The processor 302 may then cause the RDMS 102 to identify a geographical location of the computing device 104. Thereafter, the processor 302 may cause the RDMS 102 to determine if the geographical location of the computing device 104 is within a predetermined range of at least one of expected geographical locations of the consignee. Based on the determination, the processor 302 may cause the RDMS 102 to verify authenticity of the consignee based on determination of the geographical location of the computing device 104.

The processor 302 may then cause the RDMS 102 to log on the consignee onto the consignee portal. The processor 302 may cause the RDMS 102 to log on the consignee onto the consignee portal based on the first information. Further, the processor 302 may cause the RDMS 102 to log on the consignee onto the consignee portal to provide information corresponding to the product associated with the product recall drive. The manner in which the RDMS 102 authenticates the consignee is further described in conjunction with the forthcoming figures.

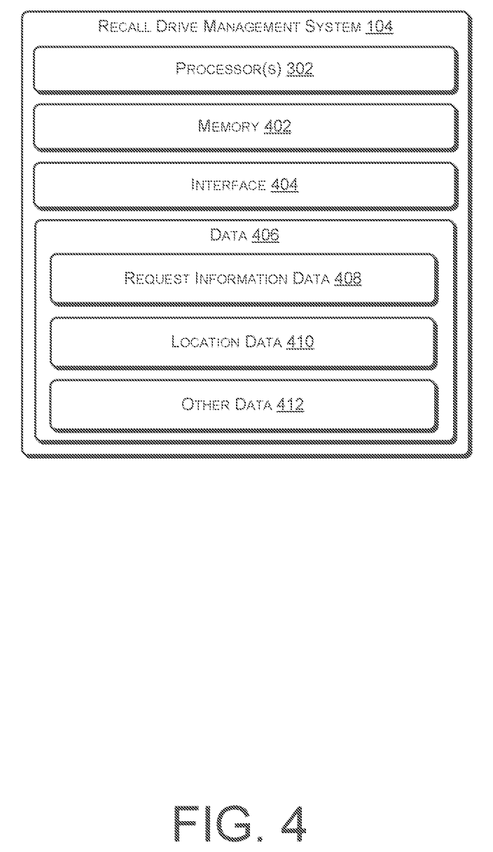

FIG. 4 illustrates the schematic of the RDMS 102, in accordance with another example of the present subject matter.

The RDMS 102 may comprise the processor 302, a memory 402, and an interface 404 coupled to the memory 402. The functions of various elements shown in the figs., including any functional blocks labelled as “processor”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly comprise, without limitation, digital signal processor (DSP) hardware, network processor, application specific integrated circuit (ASIC), field programmable gate array (FPGA). Other hardware, standard and/or custom, may also be coupled to the processor.

The memory 402 may be a computer-readable medium, examples of which comprise volatile memory (e.g., RAM), and/or non-volatile memory (e.g., Erasable Programmable read-only memory, i.e., EPROM, flash memory, etc.). The memory 402 may be an external memory, or internal memory, such as a flash drive, a compact disk drive, an external hard disk drive, or the like. The memory 402 may further comprise data which either may be utilized or generated during the operation of the RDMS 102.

The interface 404 may allow the connection or coupling of the RDMS 102 with one or more other devices, through a wired (e.g., Local Area Network, i.e., LAN) connection or through a wireless connection (e.g., Bluetooth®, WiFi). The interface 404 may also enable intercommunication between different logical as well as hardware components of the RDMS 102.

The RDMS 102 may further comprise data 406 that may be utilized or generated by the processor 302 while performing a variety of functions. In an example, the data 406 comprises request information data 408, location data 410, and other data 412. The other data 412, amongst other things, may serve as a repository for storing data that is processed, received, or generated as a result of the execution of the instructions by the processor 302. In an example, the data 406 may be stored in the memory 402.

In operation, the processor 302 may cause the RDMS 102 to receive the logon request from the computing device 104. The logon request may correspond to the consignee of the product associated with the product recall drive. Further, the logon request may include the first information to facilitate logon of the consignee onto the consignee portal. The first information may include at least one of the first information comprises at least one of Unified Resource Locator (URL) to the consignee portal and consignee login credentials for the consignee portal. The processor 302 may then cause the RDMS 102 to store the first information in the request information data 408.

In an example, the first information may be obtained upon scanning of a unique visual code corresponding to the consignee through the computing device 104. The unique visual code may be a QR code, barcode, or other machine-readable code provided to the consignee as part of the product recall drive communication. The unique visual code may be printed on the physical mail 106 received by the consignee as a part of the product recall drive. Further, the physical mail 106 may have been sent to the consignee for requesting the consignee to provide information corresponding to the product associated with the product recall drive.

The processor 302 may then cause the RDMS 102 to determine a geographical location of the computing device 104. The processor 302 may cause the RDMS 102 to identify the geographical location of the computing device 104 in various ways.

In an example, to identify the geographical location of the computing device 104, the processor 302 may cause the RDMS 102 to query a location tracking application installed on the computing device 104 for identifying the geographical location of the computing device 104. In the example, the location tracking application may rely on data received from a Global Positioning System (GPS) module included in the computing device 104 for tracking the geographical location of the computing device 104. Alternatively, the location tracking application may determine the location of the computing device 104 based on triangulation-based location determination methods.

In another example, the processor 302 may cause the RDMS 102 to identify the geographic location of the computing device 104 based on the Internet Protocol (IP) address of the computing device 104. In the example, the processor 302 may cause the RDMS 102 to obtain the IP address of the computing device 104 from the logon request and determine the geographical location by querying a geolocation database correlating IP address ranges with different geographical locations. The processor 302 may then cause the RDMS 102 to store the geographical location of the computing device 104 in the location data 410.

Once the geographical location of the computing device 104 is identified, the processor 302 may cause the RDMS 102 to determine if the geographical location of the computing device 104 is within a predetermined range of at least one of expected locations of the consignee. In an example, the processor 302 may cause the RDMS 102 to determine the expected locations of the consignee based on a travel history of the consignee. For instance, the processor 302 may cause the RDMS 102 to analyse patterns in the consignee's historical location data to predict locations where the consignee is likely to be on a given day.

The expected locations may include the consignee's residence, workplace, frequently visited clients' offices, or regular leisure destinations. The processor 302 may also cause the RDMS 102 to consider the day of the week and time of day when determining expected locations. For example, on weekdays between 9 AM and 5 PM, the consignee may have a high probability of being at their workplace or a client's office. On weekends, expected locations might include the consignee's home, a local park, or a shopping centre frequently visited by the consignee. The processor 302 may also cause the RDMS 102 to account for recurring events, such as weekly sports practices or monthly business meetings at specific locations. Additionally, the processor 302 may cause the RDMS 102 to factor in seasonal variations, such as summer vacation spots or winter holiday destinations that the consignee visits annually. By considering these temporal and spatial patterns, the processor 302 may cause the RDMS 102 to generate a dynamic set of expected locations that evolve based on the consignee's habits and routines.

In response to the determination, the processor 302 may cause the RDMS 102 to verify the authenticity of the consignee. For instance, if the geographical location of the computing device 104 is determined to be withing the predetermined range of at least one of the expected geographical locations, the processor 302 may cause the RDMS 102 to at least presume that the computing device 104 is in possession of the consignee and the physical mail was not intercepted by any unauthorized individual.

In an example, upon verifying the authenticity of the consignee, the processor 302 may cause the RDMS 102 to log on the consignee onto the consignee portal. In the example, the processor 302 may cause the RDMS 102 to log on the consignee based on the first information. In case the consignee portal is hosted on the RDMS 102, the processor 302 may cause the RDMS 102 to utilize the consignee login credentials for logging on the consignee onto the consignee portal. Alternatively, in case where the consignee portal is hosted on a third-party server communicatively coupled to the RDMS 102, the processor 302 may cause the RDMS 102 to utilize the URL included in the first information to access the consignee portal and utilize the consignee login credentials for logging on the consignee onto the consignee portal. The processor 302 may cause the RDMS 102 to log on the consignee onto the consignee to provide information corresponding to the product associated with the product recall drive.

In another example, upon verifying the authenticity of the consignee, the processor 302 may cause the RDMS 102 to generate an authentication token for authenticating the consignee at the consignee portal hosted at the resource server 202. The authentication token may be a unique, time-limited digital credential that grants the consignee access to the consignee portal without requiring repeated authentication. The processor 302 may cause the RDMS 102 to generate the authentication token based on the first information. The authentication token may include, but is not limited to, information such as a unique identifier for the consignee, a timestamp of token creation, an expiration time, and a digital signature to ensure the token's integrity.

In some examples, the processor 302 may cause the RDMS 102 to generate the authentication token using industry-standard protocols, such as JSON Web Tokens (JWT), SAML (Security Assertion Markup Language), or OAuth 2.0. It would be noted that generating the authentication tokens based on these protocols may provide a standardized format for creating and validating tokens, thereby enhancing interoperability and security.

The processor 302 may then cause the RDMS 102 to transmit the authentication token to the computing device 104. The processor 302 may cause the RDMS 102 to transmit the authentication token over a secure channel, such as HTTPS, to prevent interception or tampering of the authentication token. Further, the processor 302 may cause the RDMS 102 to transmit the authentication token as part of an HTTP response, embedded in a URL, or through a dedicated Application Programming Interface (API) endpoint. In an example, the processor 302 may also cause the RDMS 102 to implement token binding, tying the authentication token to specific characteristics of the computing device 104, such as IP address or a unique device identifier, to prevent token theft and unauthorized use from different devices. The computing device 104, upon receiving the authentication token, may utilize the authentication token to log on the consignee onto the consignee portal hosted on the resource server 202.

In yet another example, upon verifying the authenticity of the consignee, the processor 302 may cause the RDMS 102 may re-verify the authenticity of the consignee. In the example, for re-verifying the authenticity of the consignee, the processor 302 may cause the RDMS 102 to receive a user input regarding an authentication question. The authentication question may include questions related to personal information, such as consignee's personal details that are not easily accessible to others, e.g. last four digits of their tax identification number or the mother's maiden name of the consignee; questions related to transactions corresponding to the consignee, such as transactions or interactions between the consignee and the entity managing the recall, e.g. "What was the date of your last product order?" or "What was the quantity of your most recent shipment?"; questions related to the product to be recalled, such as "What is the serial number of the recalled product in your possession?" or "What is the manufacturing date printed on the product package?"; and questions related to the entity initiating the recall, such as "Who is your assigned account manager?" or "In which year did you become our customer?.

In an example, to receive the user input, the processor 302 may cause the RDMS 102 to provide a prompt on the computing device 104 for the consignee to input a value corresponding to the authentication question. The prompt may be displayed as a pop-up window, a separate webpage, or integrated into the existing user interface of the consignee portal. In the example, the processor 302 may cause the RDMS 102 to change the authentication question for each re-verification.

The processor 302 may then cause the RDMS 102 to compare the user input with a pre-stored value of the authentication question. If it is determined that the user input, i.e., the value corresponding to the authentication question, and the pre-stored value of the authentication question are the same, the processor 302 may cause the RDMS 102 to re-verify the authenticity of the consignee.

In an example, the processor 302 may also cause the RDMS 102 to count instances of discrepancy in the user input and the pre-stored value of the authentication question. In the example, if a count of instance of discrepancy is determined to be beyond a threshold, the processor 302 may cause the RDMS 102 to lock the consignee out of the consignee portal.

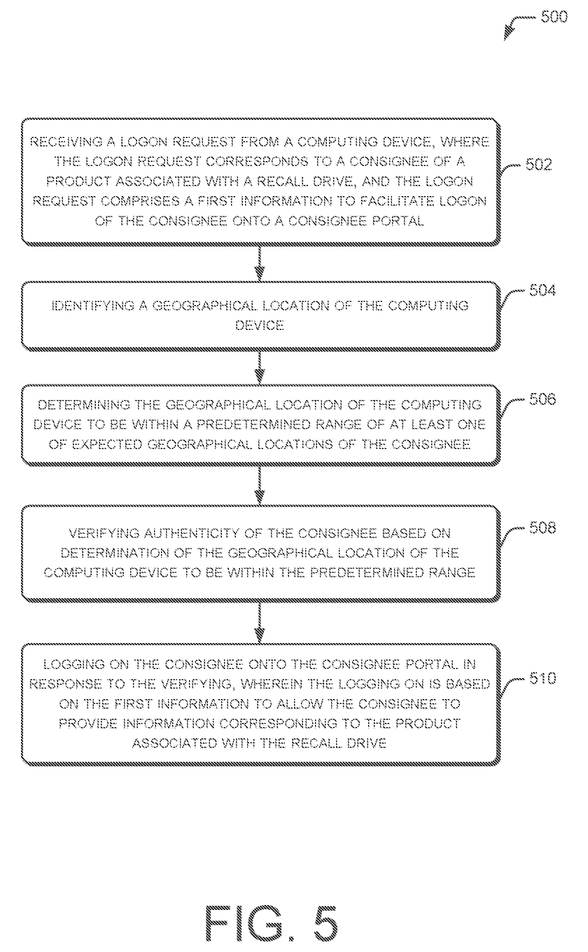

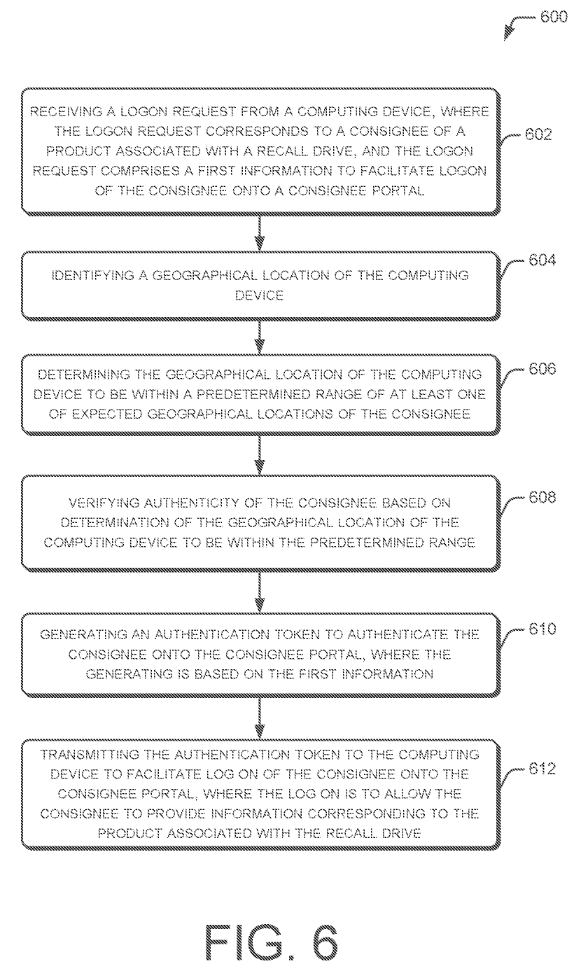

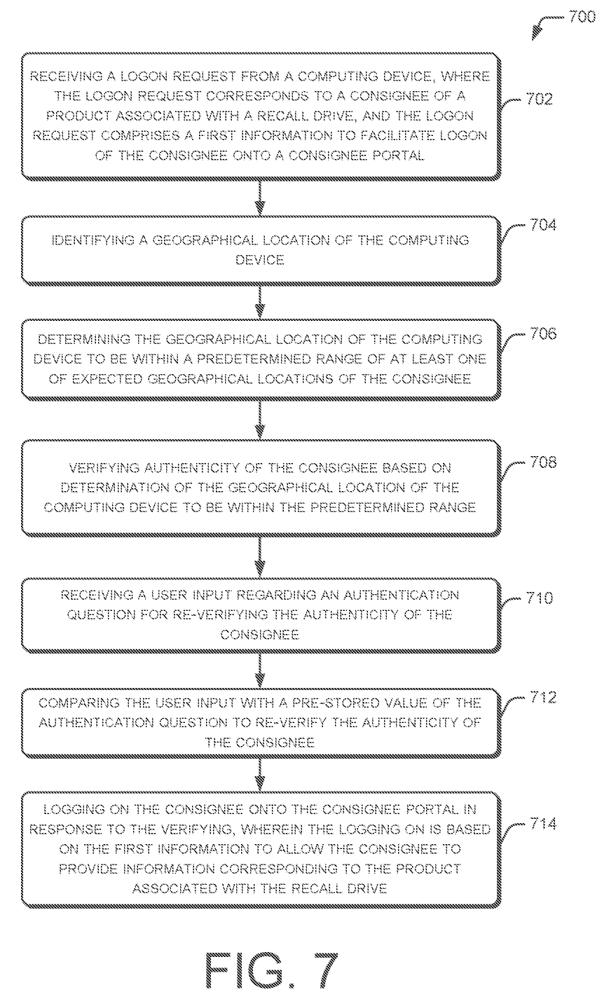

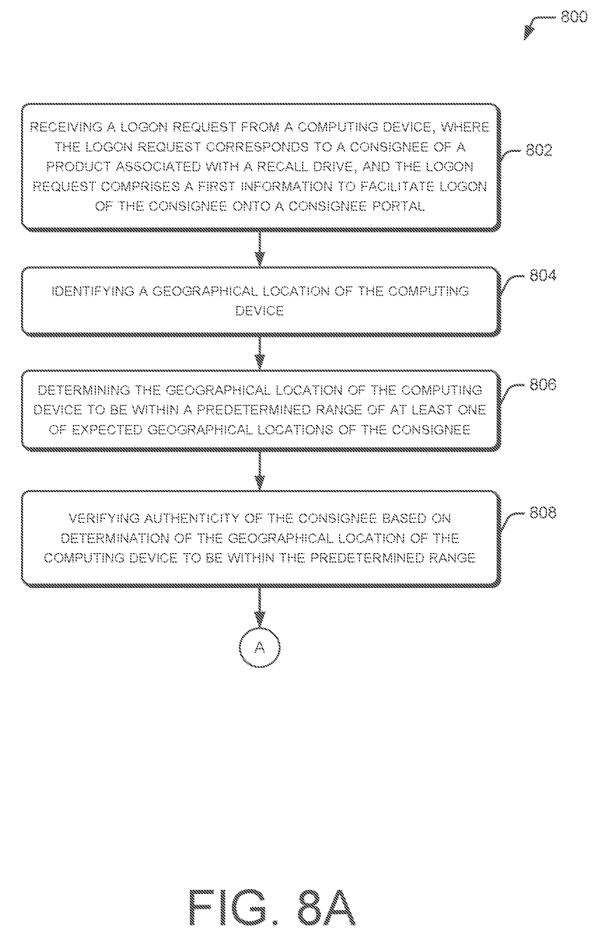

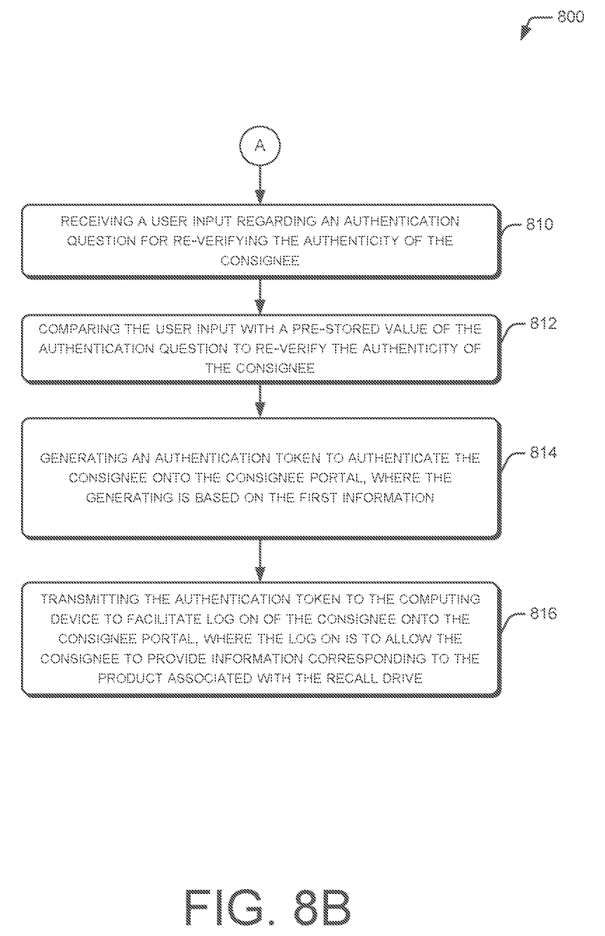

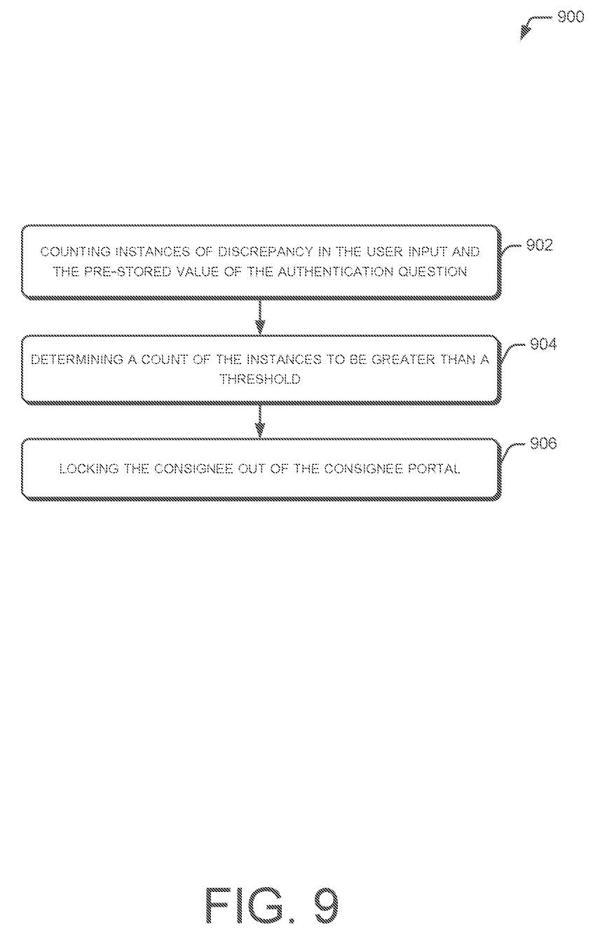

FIG. 5, FIG. 6, FIG. 7, FIGS. 8A and 8B, and FIG. 9 illustrate methods for managing product recall drives, in accordance with examples of the present subject matter. The order in which the method steps are described is not intended to be construed as a limitation, and any number of the described method blocks may be combined in any order to implement the methods, or an alternative method. Further, the methods 500, 600, 700, 800, and 900 may be implemented by processing resource or computing device(s) through any suitable hardware, non-transitory machine-readable instructions, or combination thereof.

It may also be understood that methods 500, 600, 700, 800, and 900 may be performed by programmed computing devices, such as the RDMS 102. Furthermore, the methods 500, 600, 700, 800, and 900 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 500, 600, 700, 800, and 900 are described below with reference to the RDMS 102, as described above; other suitable systems for the execution of these methods may also be utilized. Additionally, implementation of the method is not limited to such examples.

In FIG. 5, at block 502, a logon request is received from a computing device. The logon request corresponds to a consignee of a product associated with a product recall drive. The logon request comprises first information to facilitate logon of the consignee onto a consignee portal. The first information includes at least one of URL to the consignee portal and consignee login credentials for the consignee portal. In an example, the first information may be obtained upon scanning of a unique visual code corresponding to the consignee, through the computing device. The unique visual code may be a QR code, barcode, or other machine-readable code provided to the consignee as part of the product recall drive communication.

At block 504, a geographical location of the computing device is identified. In an example, the geographical location may be determined by querying location services on the computing device, using IP geolocation, or other suitable techniques for determining the computing device's location.

At block 506, it is determined whether the geographical location of the computing device is within a predetermined range of at least one of expected geographical locations of the consignee. In an example, the expected geographical locations may be determined based on known addresses, historical location data, or other information associated with the consignee.

At block 508, authenticity of the consignee is verified based on determination of the geographical location of the computing device to be within the predetermined range. The location-based verification helps ensure that the logon request is likely coming from the intended consignee.

At block 510, in response to verifying the authenticity, the consignee is logged onto the consignee portal. The logging on is based on the first information obtained from the logon request. The log on allows the consignee to access the portal and provide information corresponding to the product associated with the product recall drive.

FIG. 6 illustrates the method for managing product recall drives, in accordance with another example of the present subject matter.

In FIG. 6, at block 602, a logon request is received from a computing device. The logon request corresponds to a consignee of a product associated with a product recall drive. The logon request comprises first information to facilitate logon of the consignee onto a consignee portal. In an example, the first information may be obtained upon scanning of a unique visual code corresponding to the consignee, through the computing device.

At block 604, a geographical location of the computing device is identified. In an example, the geographical location may be determined by querying location services on the computing device, using IP geolocation, or other suitable techniques for determining the device's location.

At block 606, it is determined whether the geographical location of the computing device is within a predetermined range of at least one of expected geographical locations of the consignee. In an example, the expected geographical locations may be determined based on known addresses, historical location data, or other information associated with the consignee.

At block 608, authenticity of the consignee is verified based on determination of the geographical location of the computing device to be within the predetermined range. The location-based verification helps ensure that the logon request is likely coming from the intended consignee.

At block 610, in response to verifying the authenticity of the consignee, an authentication token is generated. The authentication token may be generated based on the first information and may serve as a secure credential for accessing the consignee portal.

At block 612, the authentication token is transmitted to the computing device. The authentication token facilitates log on of the consignee onto the consignee portal, enabling the consignee to provide information corresponding to the product associated with the product recall drive.

FIG. 7 illustrates a method for managing product recall drives, in accordance with yet another example of the present subject matter.

In FIG. 7, at block 702, a logon request is received from a computing device. The logon request corresponds to a consignee of a product associated with a product recall drive. The logon request comprises first information to facilitate logon of the consignee onto a consignee portal. The first information includes at least one of URL to the consignee portal and consignee login credentials for the consignee portal. In an example, the first information may be obtained upon scanning of a unique visual code corresponding to the consignee, through the computing device. The unique visual code may be a QR code, barcode, or other machine-readable code provided to the consignee as part of the product recall drive communication.

At block 704, a geographical location of the computing device is identified. In an example, the geographical location may be determined by querying location services on the computing device, using IP geolocation, or other suitable techniques for determining the device's location.

At block 706, it is determined whether the geographical location of the computing device is within a predetermined range of at least one of expected geographical locations of the consignee. In an example, the expected geographical locations may be determined based on known addresses, historical location data, or other information associated with the consignee.

At block 708, authenticity of the consignee is verified based on determination of the geographical location of the computing device to be within the predetermined range. The location-based verification helps ensure that the logon request is likely coming from the intended consignee.

At block 710, a user input regarding an authentication question is received for re-verifying the authenticity of the consignee. The re-verification of the consignee’s authenticity based on the user input regarding the authentication question provides an extra layer of security to the authentication process.

At block 712, the user input is compared with a pre-stored value of the authentication question to re-verify the authenticity of the consignee. The re-verification of the consignee’s authenticity helps ensure that the person attempting to log on is indeed the intended consignee.

At block 714, in response to verifying the authenticity of the consignee, the consignee is logged onto the consignee portal. The logging on is based on the first information to allow the consignee to provide information corresponding to the product associated with the product recall drive.

FIGS. 8A and 8B illustrate a method for managing product recall drives, in accordance with yet another example of the present subject matter.

At block 802, a logon request is received from a computing device. The logon request corresponds to a consignee of a product associated with a product recall drive. The logon request comprises first information to facilitate logon of the consignee onto a consignee portal. In an example, the first information may be obtained upon scanning of a unique visual code corresponding to the consignee, through the computing device.

At block 804, a geographical location of the computing device is identified. In an example, the geographical location may be determined by querying location services on the computing device, using IP geolocation, or other suitable techniques for determining the device's location.

At block 806, it is determined whether the geographical location of the computing device is within a predetermined range of at least one of expected geographical locations of the consignee. The expected geographical locations may be based on known addresses, historical location data, or other information associated with the consignee.

At block 808, authenticity of the consignee is verified based on determination of the geographical location of the computing device to be within the predetermined range. This location-based verification helps ensure that the logon request is likely coming from the intended consignee.

At block 810, a user input regarding an authentication question is received for re-verifying the authenticity of the consignee. The re-verification of the consignee’s authenticity based on the user input regarding the authentication question provides an extra layer of security to the authentication process.

At block 812, the user input is compared with a pre-stored value of the authentication question to re-verify the authenticity of the consignee. The re-verification of the consignee’s authenticity helps ensure that the person attempting to log on is indeed the intended consignee.

At block 814, in response to verifying the authenticity of the consignee, an authentication token is received. The authentication token may be generated based on the first information and may serve as a secure credential for accessing the consignee portal.

At block 816, the authentication token is transmitted to the computing device. The authentication token facilitates log on of the consignee onto the consignee portal, enabling the consignee to provide information corresponding to the product associated with the product recall drive.

FIG. 9 illustrates a method for managing product recall drives, in accordance with yet another example of the present subject matter. The method 900 may be performed in situations where the consignee’s authenticity is re-verified based on a user input regarding an authentication question before to logging on the consignee onto the consignee portal. The method 900 may be performed in situations when the user input received from the consignee and the pre-stored value of the authentication question are compared and found to be different. In such a situation, the consignee may be asked to provide another user input regarding a different authentication question.

At block 902, instances of discrepancy in the user input and the pre-stored value of the authentication question are counted.

At block 904, a count of the instances of discrepancy is determined to be greater than the threshold.

At block 906, the consignee is locked out of the consignee portal. In an example, the consignee may be locked out of the consignee portal for a predetermined time period.

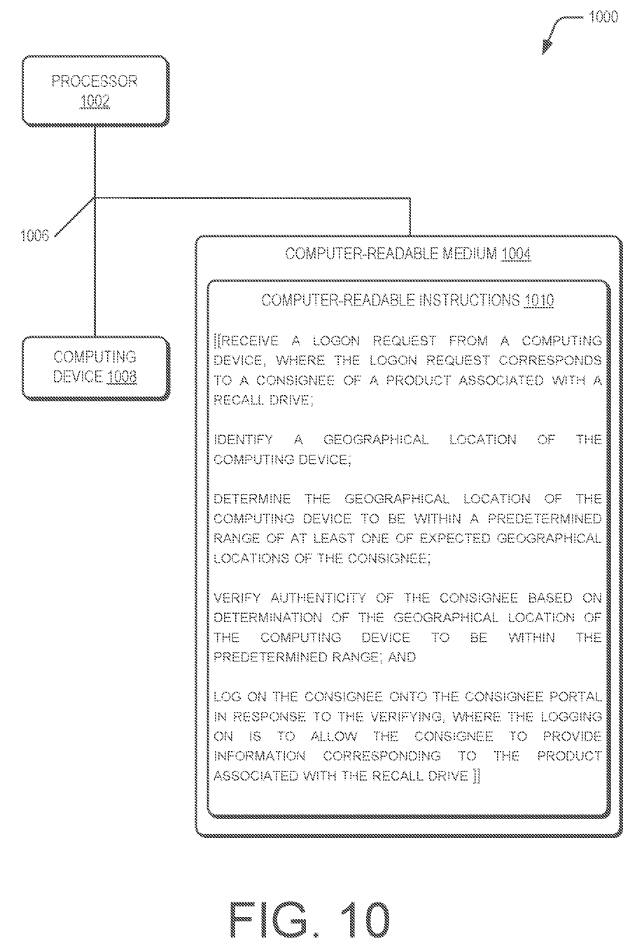

FIG. 10 illustrates a non-transitory computer-readable medium for managing product recall drives, in accordance with an example of the present subject matter.

In an example, the computing environment 1000 includes processor 1002 communicatively coupled to a non-transitory computer readable medium 1004 through communication link 1006. In an example implementation, the computing environment 1000 may be for example, the RDMS 102. In an example, the processor 1002 may have one or more processing resources for fetching and executing computer-readable instructions from the non-transitory computer readable medium 1004. The processor 1002 and the non-transitory computer readable medium 1004 may be implemented, for example, in the RDMS 102.

The non-transitory computer readable medium 1004 may be, for example, an internal memory device or an external memory. In an example implementation, the communication link 1006 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 1004 includes a set of computer readable instructions 1010 which may be accessed by the processor 1002 through the communication link 1006 and subsequently executed for facilitating management of product recall drives. The processor(s) 1002 and the non-transitory computer readable medium 1004 may also be communicatively coupled to a computing device 1008 over the network.

Referring to FIG. 10, in an example, the non-transitory computer readable medium 1004 includes computer readable instructions 1010 that cause the processor 1002 to receive the logon request from the computing device. The logon request may correspond to the consignee of the product associated with the product recall drive. Further, the logon request may include the first information to facilitate logon of the consignee onto the consignee portal. The first information may include at least one of URL to the consignee portal and consignee login credentials for the consignee portal. In an example, the first information may be obtained upon scanning of a unique visual code corresponding to the consignee through the computing device.

The instructions 1010 may then cause the processor 1002 to identify a geographical location of the computing device 104. Thereafter, the instructions 1010 may cause the processor 1002 to determine if the geographical location of the computing device 104 is within a predetermined range of at least one of expected geographical locations of the consignee. Based on the determination, the instructions 1010 may cause the processor 1002 to verify authenticity of the consignee based on determination of the geographical location of the computing device 104.

The instructions 1010 may then cause the processor 1002 to log on the consignee onto the consignee portal. The instructions 1010 may cause the processor 1002 to log on the consignee onto the consignee portal based on the first information. The instructions 1010 may cause the processor 1002 to log on the consignee onto the consignee portal to provide information corresponding to the product associated with the product recall drive.

In an example, prior to logging on the consignee onto the consignee portal, the instructions 1010 may cause the processor 1002 to re-verify the authenticity of the consignee. In the example, for re-verifying the authenticity of the consignee, the instructions 1010 may cause the processor 1002 to receive a user input regarding an authentication question. The authentication question may include questions related to personal information, questions related to transactions corresponding to the consignee, questions related to the product to be recalled, questions related to the entity initiating the recall, or a combination thereof.

To receive the user input, the instructions 1010 may cause the processor 1002 to provide a prompt on the computing device 104 for the consignee to input a value corresponding to the authentication question. In an example, the instructions 1010 may cause the processor 1002 to change the authentication question for each re-verification.

The instructions 1010 may then cause the processor 1002 to compare the user input with a pre-stored value of the authentication question. If it is determined that the user input, i.e., the value corresponding to the authentication question, and the pre-stored value of the authentication question are the same, the instructions 1010 may cause the processor 1002 to re-verify the authenticity of the consignee. In an example, the instructions 1010 may cause the processor 1002 to count instances of discrepancy in the user input and the pre-stored value of the authentication question. In the example, if a count of instance of discrepancy is determined to be beyond a threshold, the instructions 1010 may cause the processor 1002 to lock the consignee out of the consignee portal.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method comprising:
receiving a logon request from a computing device, wherein the logon request corresponds to a consignee of a product associated with a product recall drive, the logon request comprises a first information to facilitate logon of the consignee onto a consignee portal, and the first information is obtained upon scanning of a unique visual code corresponding to the consignee, through the computing device;
identifying a geographical location of the computing device;
determining the geographical location of the computing device to be within a predetermined range of at least one of expected geographical locations of the consignee;
verifying authenticity of the consignee based on determination of the geographical location of the computing device to be within the predetermined range; and
logging on the consignee onto the consignee portal in response to the verifying, wherein the logging on is based on the first information to allow the consignee to provide information corresponding to the product associated with the product recall drive.

2. The method as claimed in claim 1, wherein the first information comprises at least one of Unified Resource Locator (URL) to the consignee portal and consignee login credentials for the consignee portal.

3. The method as claimed in claim 1, wherein prior to logging the consignee onto the consignee portal, the method further comprises:
receiving a user input regarding an authentication question for re-verifying the authenticity of the consignee; and
comparing the user input with a pre-stored value of the authentication question to re-verify the authenticity of the consignee.

4. The method as claimed in claim 3, comprising providing a prompt on the computing device for the consignee to input a value corresponding to the authentication question.

5. The method as claimed in claim 4, wherein the authentication question is changed for each re-verification.

6. The method as claimed in claim 3, wherein comparing the user input with the pre-stored value of the authentication question comprises:
counting instances of discrepancy in the user input and the pre-stored value of the authentication question; and
locking the consignee out of the consignee portal upon determining a count of the instances to be greater than a threshold.

7. The method as claimed in claim 3, wherein the authentication question is related to personal information of the consignee, transactions corresponding to the consignee, product to be recalled, entity initiating the product recall, or a combination thereof.

8. The method as claimed in claim 1, wherein the expected geographical locations of the consignee are determined based on a travel history of the consignee.

9. A Recall Drive Management System (RDMS) comprising:
at least one processor and at least one memory storing instructions that, when executed by the at least one processor, cause the RDMS at least to:
receive a logon request from a computing device, wherein the logon request corresponds to a consignee of a product associated with a product recall drive, the logon request comprises first information to facilitate logon of the consignee on a consignee portal, and the first information is obtained upon scanning of a unique visual code corresponding to the consignee, through the computing device;
identify a geographical location of the computing device;
determine the geographical location of the computing device to be within a predetermined range of at least one of expected geographical locations of the consignee;
verify authenticity of the consignee based on determination of the geographical location of the computing device to be within the predetermined range;
receive a user input regarding an authentication question for re-verifying the authenticity of the consignee;
compare the user input with a pre-stored value of the authentication question to re-verify the authenticity of the consignee; and
log on the consignee onto the consignee portal in response to the verifying, wherein the logging on is based on the first information to allow the consignee to provide information corresponding to the product associated with the product recall drive.

10. The RDMS as claimed in claim 9, wherein the first information comprises at least one of URL to the consignee portal and consignee login credentials for the consignee portal.

11. The RDMS as claimed in claim 9, wherein the authentication question is related to personal information of the consignee, transactions corresponding to the consignee, product to be recalled, entity initiating the product recall, or a combination thereof.

12. The RDMS as claimed in claim 9, wherein the at least one processor causes the RDMS to provide a prompt on the computing device for the consignee to input a value corresponding to the authentication question.

13. The RDMS as claimed in claim 12, wherein the authentication question is changed for each re-verification.

14. The RDMS as claimed in claim 9, wherein to compare the user input with the pre-stored value of the authentication question, the at least one processor causes the RDMS to:
count instances of discrepancy in the user input and the pre-stored value of the authentication question; and
lock the consignee out of the consignee portal upon determining a count of the instances to be greater than a threshold.

15. The RDMS as claimed in claim 9, wherein the at least one processor causes the RDMS to determine the expected geographical locations of the consignee based on a travel history of the consignee.

16. A non-transitory computer readable medium comprising computer-readable instructions that when executed cause a processing resource of a computing device to:
receive a logon request from a computing device, wherein the logon request corresponds to a consignee of a product associated with a product recall drive, the logon request comprises a first information to facilitate logon of the consignee onto a consignee portal, and the first information is obtained upon scanning of a unique visual code corresponding to the consignee, through the computing device;
identify a geographical location of the computing device;
determine the geographical location of the computing device to be within a predetermined range of at least one of expected geographical locations of the consignee;
verify authenticity of the consignee based on determination of the geographical location of the computing device to be within the predetermined range; and
log on the consignee onto the consignee portal in response to the verifying, wherein the logging on is based on the first information to allow the consignee to provide information corresponding to the product associated with the product recall drive.

17. The non-transitory computer readable medium as claimed in claim 16, wherein prior to logging the consignee onto the consignee portal, the instructions cause the computing device to:
receive a user input regarding an authentication question for re-verifying the authenticity of the consignee wherein the authentication question corresponds to at least one of the consignee and the product; and
compare the user input with a pre-stored value of the authentication question to re-verify the authenticity of the consignee.

18. The non-transitory computer readable medium as claimed in claim 17, wherein the instructions cause the computing device to provide a prompt on the computing device for the consignee to input a value corresponding to the authentication question, and wherein the authentication question is changed for each re-verification.

19. The non-transitory computer readable medium as claimed in claim 17, wherein to compare the user input with the pre-stored value of the authentication question, the instructions cause the computing device to:
count instances of discrepancy in the user input and the pre-stored value of the authentication question; and
lock the consignee out of the consignee portal upon determining a count of the instances to be greater than a threshold.

20. The non-transitory computer readable medium as claimed in claim 17, wherein:
the first information comprises at least one of URL to the consignee portal and consignee login credentials for the consignee portal; and
the authentication question is related to personal information of the consignee, transactions corresponding to the consignee, product to be recalled, entity initiating the product recall, or a combination thereof.
